(19) United States
(12) Patent Application Publication
(10) Pub. No.: US 2010/0205847 A1
(43) Pub. Date: Aug. 19, 2010

(54) Fishing rod holder extension

(76) Inventor: Richard Gregory Hawley, Bolivia, NC (US)

Correspondence Address: RICHARD G. HAWLEY, 380 HAMILTON DR. S.E., BOLIVIA, NC, 28422-7792, US

(21) Appl. No.: 12/660,043

(22) Filed: Feb. 18, 2010

Related U.S. Application Data
(60) Provisional application No. 61/208,087, filed on Feb. 18, 2009.

(51) Int. Cl. A01K 97/10

(52) U.S. Cl. 43/21.2; 114/255; 114/364

(57) ABSTRACT

A Fishing Rod Holder Extension is for insertion into an existing rod holder mounted high on a T-top. Formed in the shape of an inverted U with one leg of the U bing longer then the other leg. The shorter leg of the U is inserted into a fishing rod holder on the T-top so the longer leg will hang down below the existing rod holder where an additional rod holder may be attached in a lower position.

This application claims priority to U.S. Provisional Patent Application Ser. No. 61/208,087 filed on Feb. 18, 2009.

### BACKGROUND OF THE INVENTION

1. Field of the Invention

This invention relates to a fishing rod holder extension. In particular the present invention provides apparatus to hold a fishing rod holder such as or similar to U.S. Pat. No. D483,436 S at a lower height so a person can reach and remove a fishing rod safely and easily.

2. Description of the Prior Art

The use of fishing rod holders is known in the prior art. While these devices fulfill their respective objectives and requirements, the need for a device that allows a fishing rod holder to be set at a lower position while trolling at 1 to 7 knots an hour. Additionally, the device should be able to be removed easily when not in use.

### SUMMARY OF THE INVENTION

The rod holders mounted on the back of a T-top on a fishing boat are there to hold fishing rods while under way, going to and from a fishing spot, and while trolling, fishing at speeds of 1 to 7 knots. The rod holders on T-tops are mounted high as to prevent passengers from hitting their head on the rod holders while the boat is going to and from a fishing spot and causing injury. With the rod holders mounted high on the T-top it makes it very hard to remove a fishing rod from the rod holder when trolling and a fish has taken the bait. It is sometimes necessary to step up on something like the bait box or the side of the boat to reach the fishing rod. This is when an injury may occur if the person falls or slips and may also drop the fishing rod in the water. With the Fishing Rod Holder Extension a fishing rod holder such as or similar to U.S. Pat. No. D483,436 S mounted on the device can be set at a lower position so a person would not have to climb up to remove the fishing rod from the rod holder that is mounted high on the T-top. The fishing rod holder extension can easily be removed when not in use.

### BRIEF DESCRIPTION OF THE DRAWINGS

In order that the invention may be more clearly understood, the preferred embodiment thereof will now be described in detail by of example, with reference to the accompanying drawings, in which:

Drawing 1/2 is a perspective view of the fishing rod holder extension and showing how a fishing rod holder such as or similar to U.S Pat. No. D483,436 S may be mounted on to the device.

FIG. 1 on Drawing 2/2 is a side view of the fishing rod holder extension of Drawing 1/2

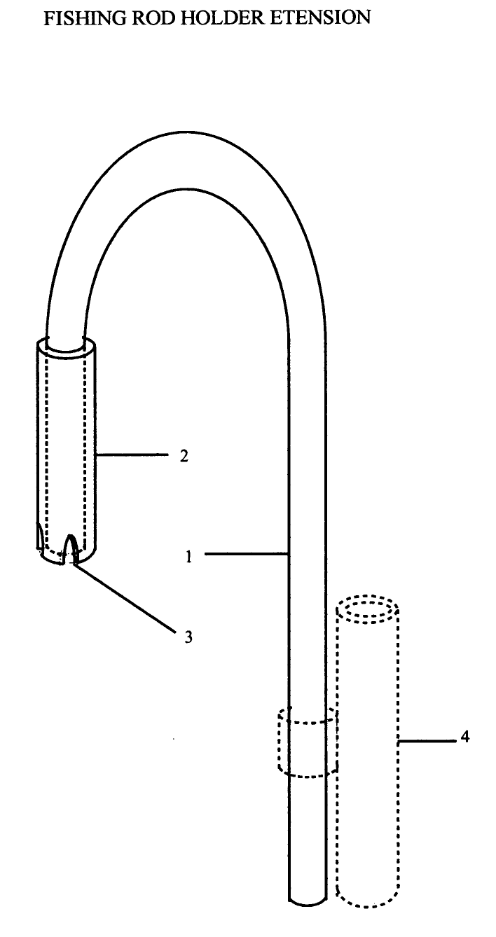

FIG. 2 on Drawing 2/2 is a front view of the fishing rod holder extension of Drawing 1/2

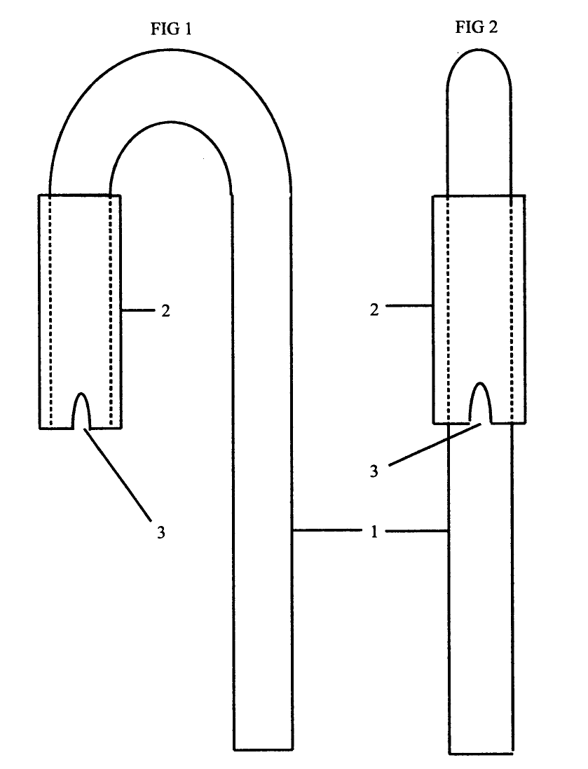

### DETAILED DESCRIPTION OF THE DRAWINGS

Drawing 1/2 Illustrates the Fishing Rod Holder Extension 1. The outside liner 2 and the four notches 3 cut at equal distance from each other at the end of rod holder extension 1 and liner 2. The clamp on type fishing rod holder 4 is for reference only and make no claims thereof.

The fishing rod holder extension 1 can be made of any material of sufficient strength such as aluminum or stainless steel. The liner 2 is to act as a cushion between the fishing rod holder extension and the rod holder on the T-top that the fishing rod holder extension is placed in.

The Fishing Rod Holder Extension is a piece of material of sufficient strength such as aluminum or stainless steel bent into a U shape with one leg of the U about twice as long as the other leg of the U. Drawing 1/2. The short leg of the U needs to be of at least 10 inches in length.

On the short leg of the U of 1 secure a piece of material such as PVC pipe or vinyl tubing 2 to cover the straight part of the short leg. The covering 2 needs to be in sufficient length, about 10 inches, so that only the notches 3 at the short leg of 1 can come in contact with the bottom of the rod holder that the Fishing Rod Holder Extension is placed in.

Cut four notched 3 at the end of the short led of the U 2 about ¼ inch wide and ½ inch deep at equal distance from each other with two being in line with the long leg of the U. Theses will fit over a bar that is at the bottom of a rod holder to keep device 1 from swinging sideways.

A “clamp on” type rod holder 4 can be purchased from any boating supply store and attached to the long leg of the U of 1.

To use the Fishing Rod Holder Extension one needs only to put the short leg of the U with the covering 2 into a rod holder that is mounted on the back side of a T-top of a fishing boat. The notches 3 should fit over the gimbal, a rod at the bottom of a fishing rod holder, to lock the device 1 straight back or turned sideways. The rod holder 4 mounted on the long leg of the U of the device 1 can now be adjusted up or down to it's highest point but so that the fisherman can still reach the fishing rod easily and safely. When fishing has stopped and before getting under way the Fishing Rod Holder Extension can be removed easily and put away.

Fishing rod holders that are mounted on the back edge of a T-top or hard top are so high that it is difficult and unsafe to remove a fishing rod from them especially when a fish has taken the bait while trolling. Trolling is pulling bait at from 1 to 7 knots. A fisherman will usually have to climb up on something like the side of the boat to reach the fishing rod. This can lead to a slip and a fall resulting in injury and the loss of the fishing rod. With the Fishing Rod Holder Extension the fisherman can without climbing safely and easily remove the fishing rod from the rod holder.

I claim that this invention is:

1. A Fishing Rod Holder Extension for insertion into a fishing rod holder on a boat comprising: a first tube having a first end and a second end, and a bend disposed between the second ends, forming a first portion of said first tube on one side of the bend and a second portion of the first tube on the opposite side of the bend, the bend forming a 180 degree angle between the first and second portion so that first portion and second portion are parallel to each other with the first portion being shorter then the second portion, a second tube is placed over the first portion of said first tube and four notches of equal size and equal distance apart are cut into the terminal end of the first portion of said first tube.

2. The Fishing Rod Holder Extension of claim 1 wherein second tube is a protective cover for first portion of said first tube.

3. The Fishing Rod Holding Extension of claim 1 wherein first portion of said first tube for insertion into a fishing rod holder on a boat.
